(19) United States
(12) Patent Application Publication
(10) Pub. No.: US 2018/0374008 A1
(43) Pub. Date: Dec. 27, 2018

(54) COMPUTERIZED SIMULATION OF CROSS ELASTICITY BASED ACTIONABLE PRICING OUTPUTS FOR SINGLE BRAND MULTI-PRODUCT SELLERS

(71) Applicant: Adobe Systems Incorporated, San Jose, CA (US)

(72) Inventors: Atanu Ranjan Sinha, Bangalore (IN); Shiv Kumar Saini, Bangalore (IN)

(73) Assignee: Adobe Systems Incorporated, San Jose, CA (US)

(21) Appl. No.: 15/633,854

(22) Filed: Jun. 27, 2017

(51) Int. Cl. G06Q 10/06; G06Q 30/02

(52) U.S. Cl. CPC G06Q 10/067; G06Q 30/0202

(57) ABSTRACT

A computer based decision simulation tool system that includes data storage containing sales data for a plurality of products in a product line of a single brand. The sales data is organized to include quantity sold, selling price and sale date of a product over a period of time, at a predetermined level of temporal granularity. A processor is operatively coupled to the storage, and the processor is configured to execute instructions that when executed cause the processor to retrieve selected portions of the sales data. The processor operates to identify dependencies among products within the product line to generate a cross-product price elasticity that is indicative of percentage change in quantity sold of a focal product with respect to one percentage change in price of a different product in the product line. The process further operates to respond to user inputs to provide visual indications of the cross-product price elasticity.

### FIELD OF THE DISCLOSURE

This disclosure relates generally to the field of data processing and more particularly to computerized simulation tools.

### BACKGROUND

Computerized on-line sales management tools are increasingly necessary to assist with online marketing and sales. Consider for example, an online, single brand seller of multiple products. For example, X brand mobile phones. When selling multiple products, the brand exposes itself to competition among its own products. That is, the price of one product may affect the purchase decision of another product in the brand's line-up of products. Hence, any change in price for one product must recognize the prices of others in the product line (holding the set of products in the product line constant). Current on-line marketing systems fail to adequately address this complicated problem which requires uncovering dependencies among prices and products in a product line (which often comprises many products that may be substitutable and complementary). What is needed is a simulation tool that permits systematic, objective, efficient and repeatable simulation of product sales and the effects of intra-brand competition.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive techniques disclosed herein. Specifically:

FIG. 1A is high level block diagram of a system generating computerized analysis and recommendations for pricing determination in accordance with embodiments of the invention.

FIG. 1B is a screenshot showing further details of the pricing dashboard of FIG. 1.

FIG. 2A is a flowchart illustrating operation at high level of the system of FIG. 1.

FIG. 2B is a flowchart illustrating further details of feature selection.

FIG. 2C is a flowchart illustrating further details of model generation.

FIG. 3 provides details of temporal aggregation of sales data.

FIG. 4 is a table showing example sales data.

FIGS. 5, 6 and 7 are screenshots showing output provided by the system when generating computerized analysis and recommendations for pricing determination.

FIG. 8 illustrates a block diagram of hardware that may be employed in various embodiments.

### DETAILED DESCRIPTION

In the following detailed description, reference will be made to the accompanying drawings, in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

The systems, methods and computer-readable media disclosed herein provide rapid, objective, computerized solutions that permit a product marketer to simulate pricing changes and the effects of the pricing changes on the product whose price is being changed and on other products in the product line. The products can vary significantly in prices across the line. The disclosed computerize techniques address a fundamental problem of product line pricing, faced by online sellers and offline sellers. In the disclosed techniques, systematic regression analysis is performed to generate a cross product price elasticity matrix which captures the dependencies among products in a product line of a single brand. Cross product price elasticity as referred to herein is the percentage change in quantity sold of a focal product with respect to one percentage change in price of a different product in the product line (assuming all else is equal). The matrix may then be employed by the simulator to provide insights to a product marketer about the effects of various price changes.

On occasion a brand may offer a price discount on a product, with the goal of boosting revenue from that product. A common metric to focus on is the increased revenue for the discounted product. However, there is an unintended consequence which is often ignored. The discount can draw consumers from the brand's own other undiscounted products. It is thus important for the brand to weigh the increased revenue from the discounted product against the decreased revenue from its own undiscounted products in order to assess the true effectiveness of the discount. The disclosed computerized techniques allow the brand to measure the overall revenue impact by going beyond the revenue impact of the discounted product and recognizing the impact on revenue of own other products. This produces a truer picture of revenue impact and that of the effectiveness of the discount. Moreover, the disclosed computerized techniques determine dependencies among products in a product line of a single brand by recognizing the intra-brand competition of one product with other existing products. This permits a marketer to track the sales and revenue of the substitutes and complements as they change price of a product. Also, the disclosed computerized techniques permit assessment of overall revenue impact when a product is offered on discount or price is reduced or increased. A reporting tool incorporating the techniques disclosed herein, permit visualization of cross-product elasticities through a reporting tool. A decision simulation tool incorporating the foregoing functionality permits marketers to make informed decisions for price changes and discounts by way of objective, systematic computerized analysis of data as opposed to subjective guesses as is often done.

The disclosed systems and methods address the important aspect of determining price changes for a product to permit effective revenue management, which is fundamental for every business. The disclosed systems and methods address unfilled needs of a marketer for existing products in a product line.

Current systems fail to address the need for reporting and simulation tools amenable to a manager. As for price management, the literature provides general guidance but does not address the use case of product line price management based on observational data. By contrast there is literature which relies on experimental methods such as conjoint analysis for product line design. The disclosed systems do not require use of experiments.

The disclosed systems also differ in another important aspect from the above described existing work. Since the disclosed systems estimate a model from sales data on existing product line of a brand, they can identify dependencies among the products and recommend, if appropriate, whether and how to prune the product line. This use case is managerially very beneficial to improve profitability, but is not addressed by the above works.

Further it should be noted that in examining prices the disclosed systems confine to one-price for a product, that is, every unit of the product is sold at the same price at any given point in time.

The disclosed techniques may take the form of a computer based decision simulation tool that includes data storage containing sales data for a plurality of products in a product line of a single brand. The sales data are organized to include quantity sold, selling price and sale date of a product over a period of time, at a predetermined level of temporal granularity. A processor is operatively coupled to the storage, and the processor is configured to execute instructions that when executed cause the processor to retrieve selected portions of the sales data. The processor operates to identify dependencies among products within the product line to generate a cross-product price elasticity matrix that is indicative of percentage change in quantity sold of a focal product with respect to one percentage change in price of a different product in the product line. The processor further operates to respond to user inputs to provide visual indications of the cross-product price elasticity.

Additional aspects related to the invention will be set forth in part in the description which follows, and in part will be apparent to those skilled in the art from the description, or may be learned by practice of the invention. Aspects of the invention may be realized and attained by means of the elements and combinations of various elements and aspects particularly pointed out in the following detailed description and the appended claims.

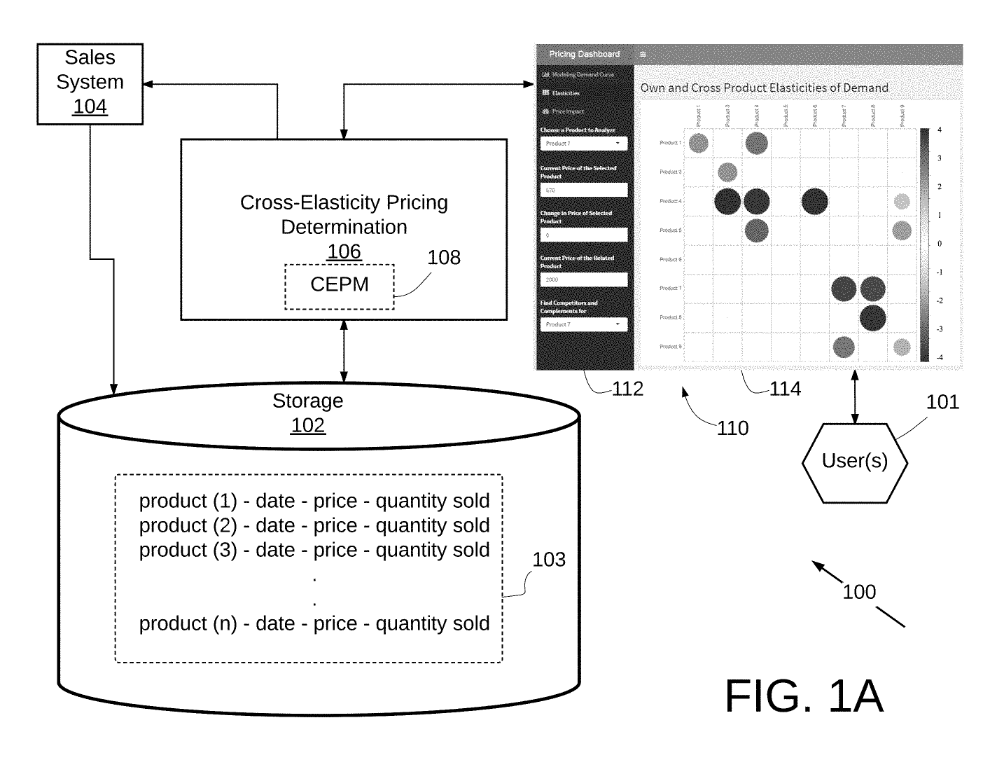

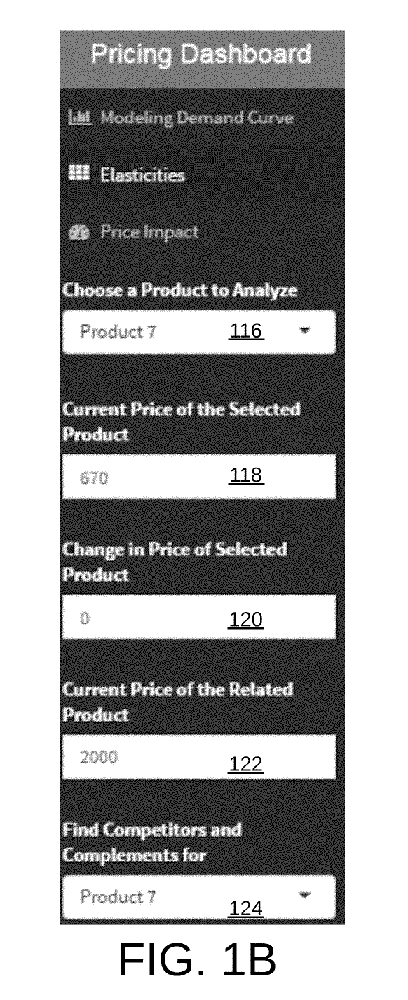

FIG. 1 is a high level block diagram illustrating an embodiment of a computer based decision simulation tool system that may be used by one or more user(s) 101. In FIG. 1, a computer system, shown generally at 100, includes digital storage 102 that stores sales data 103. The sales data 103 is organized and structured to include sales data regarding one or more products within one or more product lines of a seller. As seen at 103, the sales data may include multiple products (product (1)-product (n)) and such sales data will include sale date of a particular product, along with the price on that date and the quantity sold on that date. The sales data 103 can include data for many, such as dozens or hundreds of products and can span long time periods and can therefore be quite voluminous. The sales data 103 may be received from a sales system 104 which operates to receive data regarding product sales such as via a conventional order entry system or other mechanism employed by an organization to collect data regarding product sales. Alternatively, sales system 104 may take the form of a data analysis system employed to analyze sales data, such as Adobe Analytics, available from Adobe Systems Corporation. Digital storage 102 is shown generally but can take a variety of forms of storage for digital content including storage that is spread physically across numerous storage devices, and also that is partially or wholly distant physically from other portions of system 100.

A Cross-Elasticity Pricing Determination (CEPD) module 106 receives data 103 from storage 102 and employs a Cross-Elasticity Pricing Model 108 (which can take the form of multiple models) to identify price dependencies among products within a particular product line. User 101 may interact with the system 100 via a visual interface to show a dashboard 110 to view information generated by the system such as cross-product price elasticity that is indicative of percentage change in quantity sold of a focal product with respect to one percentage change in price of a different product in the product line. The pricing dashboard 110 includes an input area 112 by which user 101 selects products for analysis and specifies other parameters. The CEPD 106 provides the user 101 with its analysis via output area 114. Results of the CEPD 106 may be stored in storage 102 and may also be supplied to sales system 104 for use by sales system 104 in automatically updating pricing based on results of the CEPD 106.

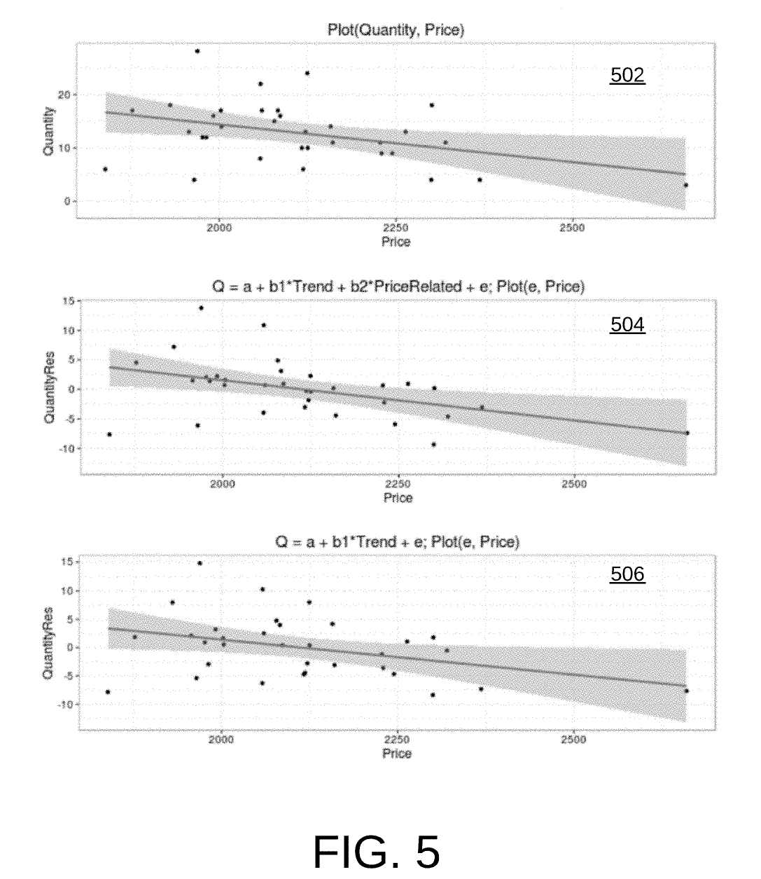

FIG. 1B is a screenshot of input area 112 of pricing dashboard 110. User 101 may select a product to analyze (116) via a dropdown menu. The other fields in the side bar are also inputs to the model. More specifically, the product input 116 selects a particular product to analyze. The price inputs 118, 120, 122 simulate the effect of change in price of a related product on overall revenue, given the starting prices of all the products. Price input 118 permits entry of the current price of the product selected at 116. Input 120 permits entry of change in price of the product selected at 116. Input 122 permits entry of the current price of the related product. User 101 may also request CEPD 106 to identify competitors and complements for an identified product (124). Further details of the pricing dashboard are provided in connection with FIGS. 5-7.

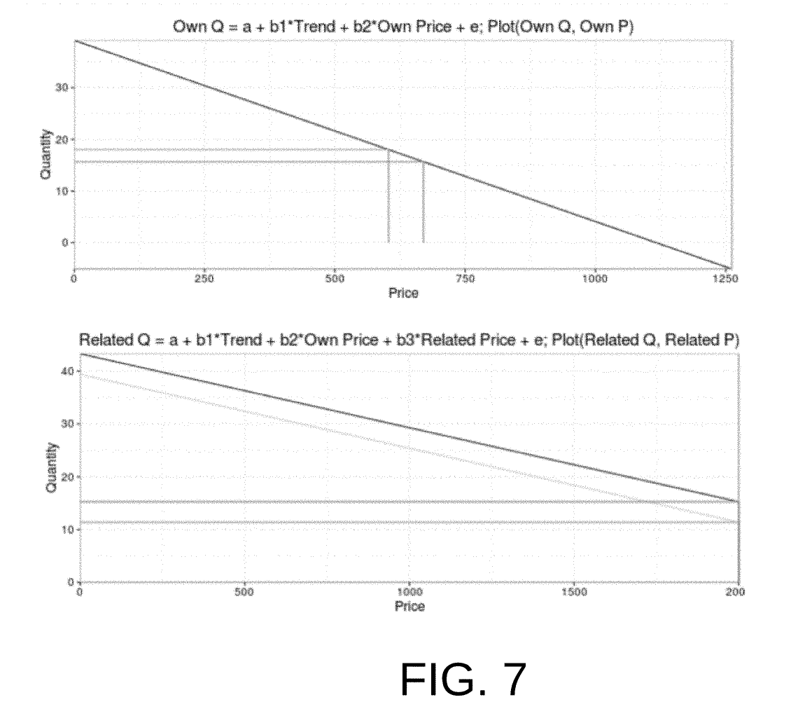

A user can select a product from the dropdown menu “Choose a Product to Analyze” 116. This allows the user to visualize the demand and quantity relationship for the chosen product as well as the relationship between the price and quantity demanded accounting for the time trend and the price of the related products. The next three input boxes 118, 120, 122 simulate the effect of a price change, starting from a chosen initial price of own as well as related product(s). This simulation result is visualized in FIG. 7. Input box 124 allows a user to provide a product as input to see the substitutes and complements for that product.

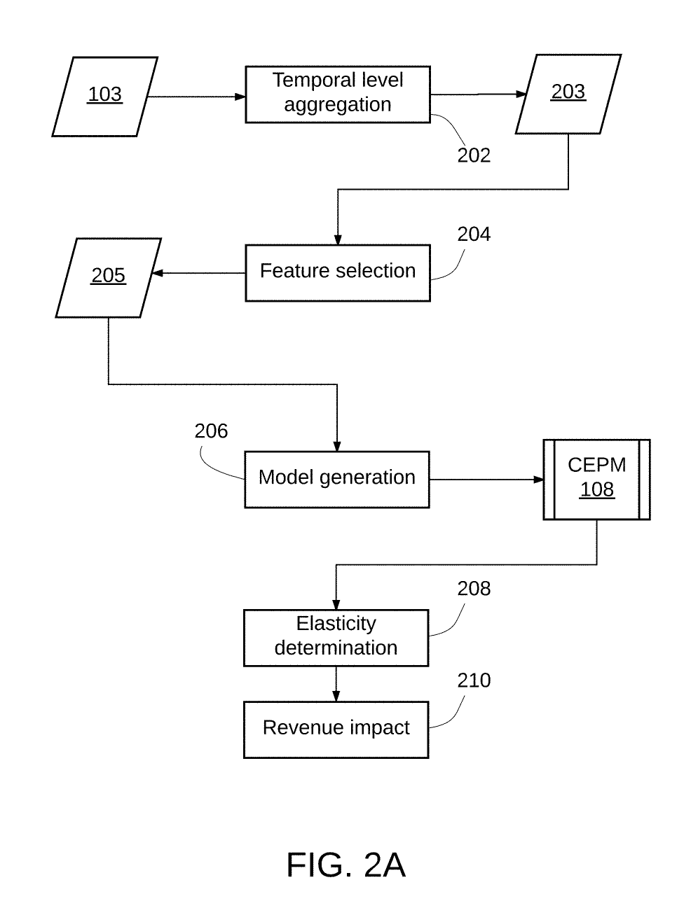

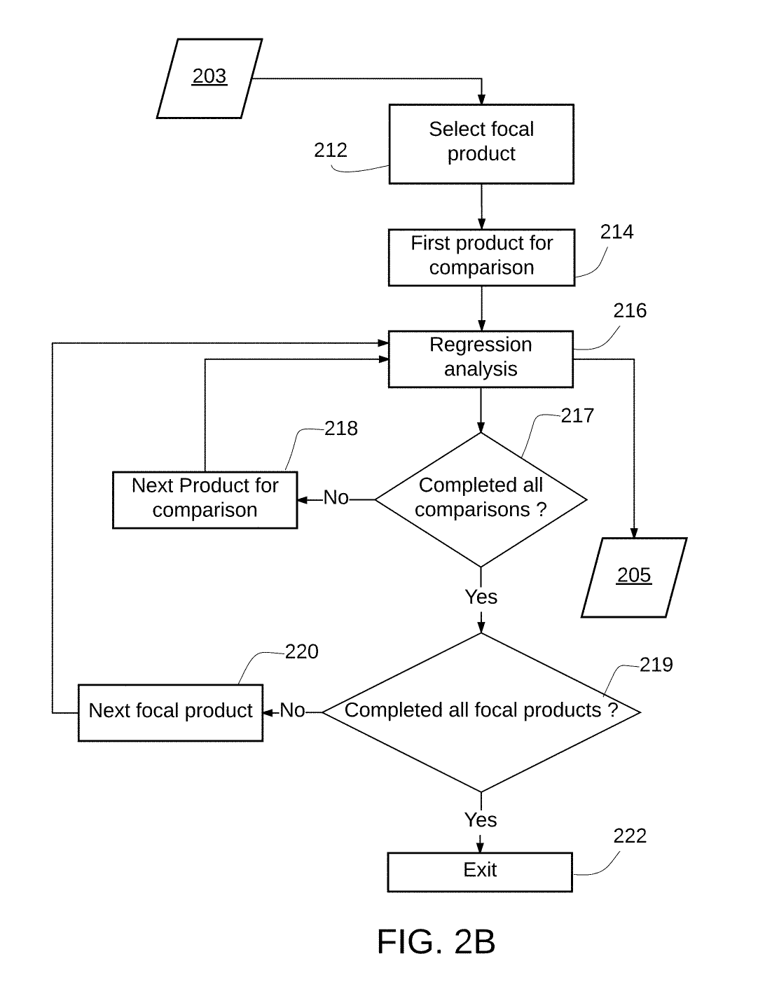

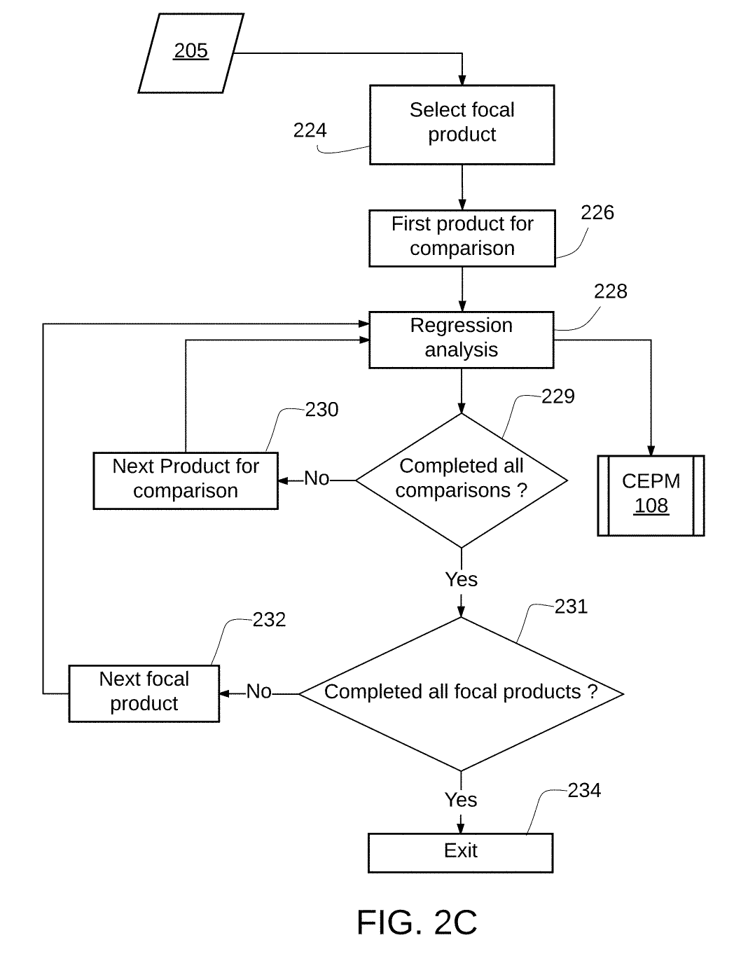

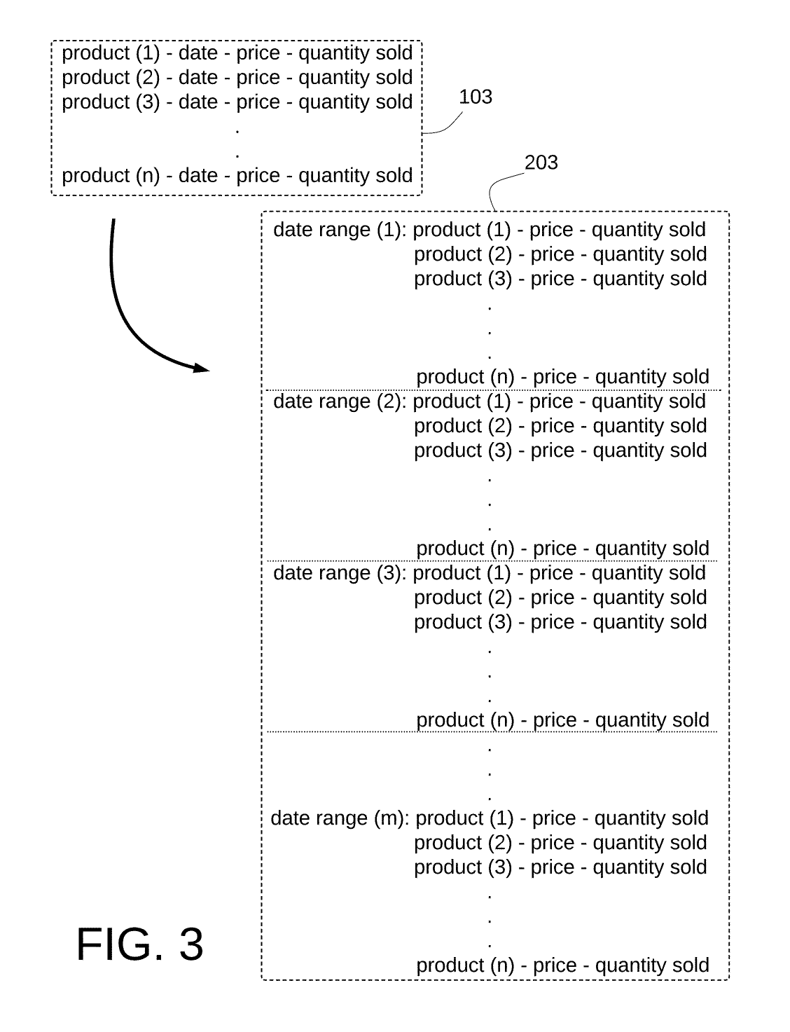

A high-level flowchart illustrating operation of the CEPD 106 is shown in FIG. 2A. The sales data 103 is aggregated at step 202 to generate aggregated sales data 203. This reduces the amount of data that must be stored and processed by the CEPD 106. As seen in further detail in FIG. 3, the sales data 103 is aggregated at a predetermined level of temporal granularity in accordance with the frequency of price changes of a product. For example, if product price changes are implemented on a weekly level then the sales data 103 is aggregated at a weekly level, which is the contiguous smallest unit of time during which price of a product remains constant. In alternative embodiments, the level of temporal granularity need not be the contiguous smallest unit of time, but this may reduce accuracy of results by CEPD 106. As seen in FIG. 3, the data 103 may be aggregated by date range, such as by week, for multiple date ranges (date range (1) through date range (m)). The aggregated data 203 for each date range includes for each product (such as product (1) through product (n)) the price in effect for that date range and the total quantity sold of that product for that date range.

Turning back to FIG. 2A, at step 204, feature selection modeling is employed, where the features of interest are the price of a product and time period, to identify products that contain price dependencies over certain time periods on other products to generate model data set 205. Allowing time as a feature accounts for expectations of price change. For example, a product whose price change is determined to not affect any other product is excluded from model data set 205. As will be appreciated by those skilled in the art, feature selection is a process by which a subset of relevant features from a data set is selected for use in model generation. Feature selection, by removing redundant or irrelevant data, permits simplification of the resulting model thereby making the model easier to implement. Feature selection also permits shorter training times which can provide a significant benefit with very large data sets. Feature selection also avoids various phenomena that arise when analyzing and organizing data with many dimensions (sometimes referred to as the “curse of dimensionality”). Finally, feature selection reduces overfitting thereby providing enhanced generalization. In certain embodiments, Least Absolute Shrinkage and Selection Operator (LASSO) regression analysis is employed for feature selection and regularization. Aspects of LASSO are described by Robert Tibshirani, in Regression shrinkage and selection via the lasso: a retrospective, J. R. Statist. Soc. B (2011) 73, Part 3, pp. 273-282. As described therein, LASSO benefits from providing estimation and variable selection simultaneously in one stage. LASSO is also employed at step 206 to subject model parameters to statistical tests for exclusion/inclusion of products that impact quantity sold of a focal product when the former changes price.

As explained by Tibshirani, LASSO solves the l₁-penalized regression problem of finding [symbol] ={ [symbol] ⱼ} in a linear regression by minimizing the following objective function:

$${\sum }_{i = 1}^{N} {( {y}_{i} - {\sum }_{j} {x}_{ij} {β}_{j} )}^{2} + λ {\sum }_{j = 1}^{p} \vert {β}_{j} \vert$$

where,
xᵢⱼ are standardized predictors. The number of such predictor (range of j) can be very large. The LASSO procedure chooses a subset of the predictor by minimizing the above optimization function. In this case, these will be prices of own and other products.
yᵢ are response values. In this case, this is the quantity demanded for the j^{th} product.
i=1, 2, . . . , N
j=1, 2, . . . , p
In the above equation, the first summation minimizes the difference between the actual value and predicted value. The second term penalizes too many parameters and helps in selecting the most important features.

FIG. 2B illustrates further details of feature selection. FIG. 2B is a flowchart illustrating the steps performed to generate model data set 205 from aggregated data 203. In the steps illustrated in FIG. 2B each product is successively selected as a focal product and tested against all other products to identify other products, the sales of which, are impacted by price changes in the focal product. A focal product is selected at 212 and a first product for comparison with the focal product is selected at 214. Regression analysis, such as described above, is performed at 216 to identify impact of price changes in the focal product on sales of the product for comparison. Results are stored into model data set 205. Step 216 is performed by testing the focal product against each other product by way of the test at 217 and selection of another product for comparison at 218. Once the focal product has been compared against all other products, another product is selected as the focal product via steps 219 and 220 and the process is repeated until each product has been tested against every other product and the routine exits at 222.

At step 206, the model data set 205 is analyzed to generate CEPM 108 which provides a relation between quantity sold and price for every product in model data set 205. The goal of the CEPM 108 is to establish a relation between quantity sold and price, for every product being considered. This relation is commonly known as the demand curve. However, typically, price is not constant; instead it typically changes. The prices of a product follow certain pattern. For example, a product is launched at a certain price and as the time goes on the price may be reduced and large discounts are offered near the end of the product lifecycle. These temporal effects are addressed in the model. The CEPM 108 addresses both the temporal effect and the effect of changes in other products' price.

At 206, a generic form of the regression model used is:

g(y)=Xβ+u

where
g admits various functional forms for y, the quantity of units sold;
X includes time and prices of own product and prices of other products;
β represents the random error.

In certain embodiments, a linear demand curve is assumed, that is, the relation between quantity and price is assumed linear. In other embodiments, other relationships may be employed such as a log-linear model where the logarithm of quantity is modeled as a linear function of price. For each focal product, the equivalent of feature selection is used within the regression model to arrive at the most appropriate model. In the disclosed embodiments, feature selection manifests in statistically choosing from among many products that subset for which their prices affect quantity sold for the focal product. Statistical significance tests are used to choose the subset.

Estimates of β are preferably used to compute elasticities. As an illustration, consider two products, i and j, with i being the focal product whose unit sales is being modeled. Suppose product j's price change affects product i's unit sales, but product i's price change does not affect product j's unit sales. Let t represent time in weeks. Time could also be in other units of measurement such as for example, days or months. The final models for elasticity determination at 208 take the form below:

Salesᵢₜ=b₀+b₁Priceᵢₜ+b₁₂Priceⱼᵢₜ

Salesⱼₜ=c₀+c₁Priceⱼₜ

Then we have product i's demand elasticity with respect to product i's own price

$${η}_{ii} = {b}_{1} \times \frac{{Price}_{i}}{{Sales}_{i}}$$

product i's demand elasticity with respect to product j's price

$${η}_{ij} = {b}_{2} \times \frac{{Price}_{j}}{{Sales}_{i}}$$

where,
Priceᵢ and Priceⱼ are average weekly prices of products i and j, respectively, and Salesᵢ is the average weekly number of units sold of product i. In general, in disclosed embodiments, aggregation is performed at the smallest level of price change unit. For example, if the smallest time period during which a product price remained constant is three days, then the price and quantity aggregation can be done at three days.

Since the calculations are all based on model estimated beta coefficients with known estimates of standard error, error bounds for ηᵢᵢ are employed for the above quantities:

$$Standard Error of {η}_{ii} , s . e . ( {η}_{ii} ) = Standard Error of {b}_{1} \times ( \frac{{PRICE}_{i}}{{SALES}_{i}} ) \\ 95 \% error bound for {η}_{ii} = {η}_{ii} \pm [ 1.96 * s . e . ( {η}_{ii} ) ]$$

Note the standard error of b₁ is automatically computed as part of a regression analysis. Other error bounds can be similarly computed.

FIG. 2C illustrates the steps performed at 206 to systematically determine price changes of a product on itself and on other products to generate CEPM 108. In the steps illustrated in FIG. 2C, the relationships identified in step 204 are modeled to generate a demand curve for each product. Advantageously, this processing can be much more efficient due to the culling of the data performed at step 204. In large datasets this can be a significant benefit. A focal product is selected at 212 and a first product for comparison with the focal product is selected at 214. Regression analysis is performed at 216 to generate a demand curve for the focal product by analyzing the focal product with respect to each other product in the dataset that has been determined at step 204 to impact the price of the focal product via the loop comprising steps 229, 230. Each product in the dataset is selected (steps 231, 232) until all products in the dataset have been analyzed to generate a demand curve for each product. Results are stored into CEPM 108 and the routine exits at 234.

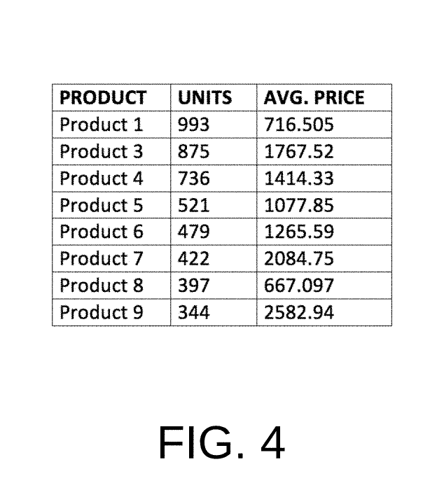

FIG. 4 shows a table containing sample data for a plurality of products within a product line with units sold and average price over a plurality of date ranges. As can be seen, there is considerable variation in quantities sold across the products, and very importantly, large variation in average prices, ranging from $667 to $2,582. This permits analysis of the CEPM's ability to capture a wide variation of products and affords a valid examination of dependencies. Naïve intuition may suggest that products in proximal price range will behave as substitutes. To allow for a fairer test, the data permits going beyond a proximal price range to test how dependencies may or may not occur when the range of prices is large.

FIGS. 5, 6, 7 and 8 are screenshots showing output provided by the system when generating computerized analysis and recommendations for pricing determination. FIG. 5 is a screen shot of an embodiment that shows quantity-price relation for a focal product in the presence of another product. These figures render the aggregate Quantity-Price relation for a focal product based on the estimated model. For the purpose of illustration, a linear relation is shown. This is not limiting since suitable non-linear relations can be included in the CEPM (for example, where natural logarithm of quantity is modeled as a linear function of price). The CEPD 106 can provide the analysis shown in FIG. 5 for all products in a product line.

The graph at 502 shows modeling of quantity as a function of price alone, in other words, a demand curve without other variables. The graph at 506 shows results of the Quantity-Price relation of the focal product when an allowance is made for time effect (brand makes price change over time and consumers form expectation), in other words, a demand curve with a temporal effect. There is a shift in the slope from that of the graph 502, it is more negative. Furthermore, allowing another product's price to enter the model produces another shift in the Quantity-Price relation of the focal product, as shown in the graph at 504, which shows a demand curve with temporal effect and related product price. This visualization of the impact of price change of one product on quantity sold of another product conveys an important insight to a user (e.g. pricing manager) about product dependencies. As well, this does a better job at conveying the insight than mere presentation of model results may achieve. The menu shown in FIG. 1B allows selection of products whose dependency interests the user.

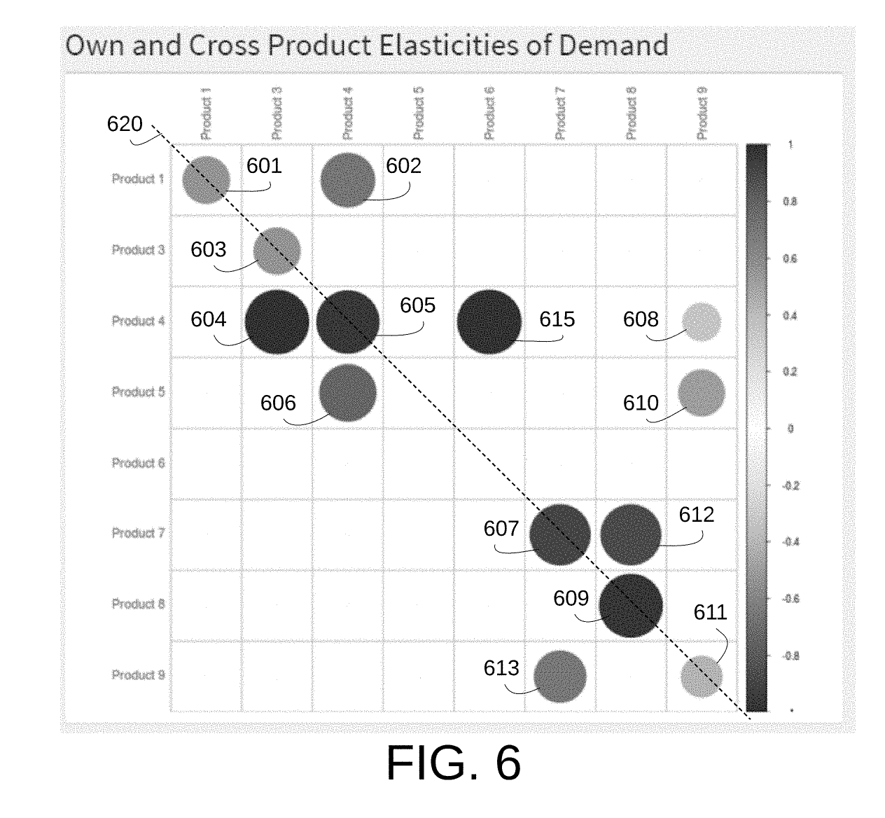

FIG. 6 illustrates an own and cross product price elasticity matrix. Own product price elasticity is the percentage change in quantity sold of a focal product with respect to one percentage change in price of the same focal product (assuming all other things are held constant). For normal goods, own price elasticity is less than zero, since a price increase (decrease) is expected to decrease (increase) quantity sold. Cross product price elasticity is the percentage change in quantity sold of a focal product with respect to one percentage change in price of a different product in the product line (ceteris paribus). For normal goods, cross price elasticity for perceived substitutes is greater than zero, since a price increase (decrease) in the other product is expected to increase (decrease) quantity sold of a focal product.

The graph in FIG. 6 is a screenshot showing an own and cross product price elasticity matrix as generated by an embodiment of CEPD 106. Products 1-9 are represented on the vertical and horizontal axes. The screenshot in FIG. 6 is a greyscale image of a color image as generated by an embodiment of CEPD 106 with the size and shade of the circle representing the magnitude of the elasticity. The circles with odd numbers (601, 603, 605, 6076, 609, 611, 613) in a color representation would be in different shades of a first color such as blue to represent own price elasticity. The circles with even numbers (602, 604, 606, 608, 610, 612) in a color representation would be in a different shades of a second color such as red to represent cross price elasticity. The elasticity in each cell is an estimate of the effect of a price change in the column product on the quantity change in the row product. For example, the cells 601 and 602 show the effect of price change in product 1 and product 4, respectively, on the quantity change in product 1. Per definition above the cell 601 captures the own product price elasticity for product 1 and as expected is less than zero. Also per definition above the cell 602 captures the cross product elasticity for product 1 due to change in price for product 4 and as expected is greater than zero. The blank cells indicate that there is no significant impact of change in price of the corresponding column-product on the change in quantity of the corresponding row-product.

The graph shown in FIG. 6 provides a number of insights to a user. First, as can be seen, own price elasticity varies quite a bit, as seen along the diagonal line 620 across the eight products. Second, own price elasticity is not necessarily related to how expensive the product is. With the highest average price as seen in FIG. 4, product 9 has a low absolute value as seen at 611, and with the lowest average price product 8 has a high absolute value as seen at 609, yet product 1 shows a low absolute value as seen at 601 although its price is very close to that of product 8. Third, all the elasticities portray that each product is in the elastic region of demand with absolute values greater than one. Fourth, coming to the off-diagonal elements, not all products' prices impact quantity sold of a given product; only a subset does. This is clear from the many blank cells. Fifth, to appreciate and understand dependencies, let the user observe the first row, column three as seen at 602. Product 1's quantity sold is affected (goes down) when product 4 decreases price, due to the price difference between the two products diminishing and drawing people to buy product 4 instead of product 1. However, when other products change price we do not see any significant impact on product 1. Sixth, and notably for the user, the impact of product 4 price change on product 1 quantity change is not symmetric. That is, we find that decrease in product 1 price does not impact unit sales of product 4. Seventh, it can be seen that similarly, other product dependencies can be unearthed by observing the matrix. In particular, product 8's price change impacts product 7 unit sales (612), but not vice versa.

FIG. 7 illustrates a what-if simulation generated by CEPD 106 Of products 7 and 8 of FIG. 4. From FIG. 6 the CEPD 106 shows that product 8 price change affects quantity sold of product 7 but the reverse does not hold. Why is this significant for the user? To answer this question, consider product 8. When considering any price change of product 8, a user typically focuses on the revenue impact on product 8 alone. That is, looking at the own price coefficient in the regression model, the user can estimate the impact of product 8 price decrease on product 8 unit sales increase and enumerate the revenue impact (revenue=price*quantity). This is depicted in graph 702 of FIG. 7 with a 10% reduction in price of product 8. As the price is reduced from the red line to the green line the quantity sold is increased. In fact, we find that the revenue for product 8 increases, thereby justifying the temporary price reduction in the minds of the manager. But, is that correct? This ignores dependency of product 8 with any other product. In this instance, product 7 unit sales are dependent on price change for product 8 as seen in FIG. 6. The price decrease of product 8 reduces quantity sold of the higher priced product 7 as depicted by the lowering of the demand line in graph 704. In this rendition, the reduction of product 7 revenue outweighs the increased revenue of product 8, resulting in a net revenue loss relative to no price reduction for product 8. In this instance, the manager is better off calling off the price reduction.

Any manager needs to understand the consequence of price change of any single product on the product line and on total revenue. The techniques employed by the CEPD 106 analyze dependency and perform a simulation which ingests the dependencies to output the net revenue impact, thereby providing a manager with a much needed tool. The manager who has access to marginal cost data can extend this revenue impact to enumerate profit impact. The embodiments disclosed herein provide analysis that allows more effective insights that directly evolves into actions.

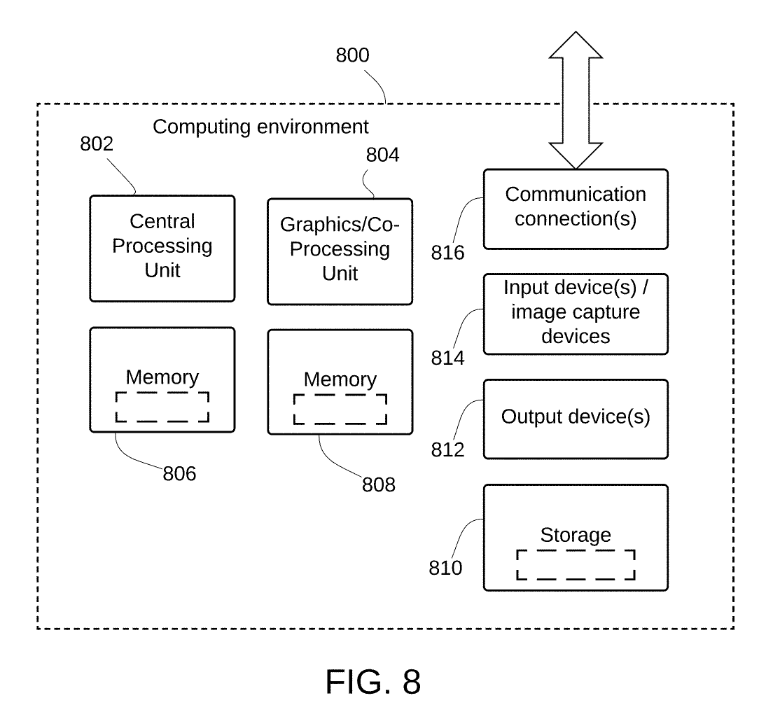

FIG. 8 depicts a generalized example of a suitable general purpose computing system 800 in which the described innovations may be implemented in order to improve the processing speed and efficiency with which the computing system 800 provides trend detection and characterization. With reference to FIG. 8, the computing system 800 includes one or more processing units 802, 804 and memory 806, 808. The processing units 802, 806 execute computer-executable instructions. A processing unit can be a general-purpose central processing unit (CPU), processor in an application-specific integrated circuit (ASIC) or any other type of processor. The tangible memory 806, 808 may be volatile memory (e.g., registers, cache, RAM), non-volatile memory (e.g., ROM, EEPROM, flash memory, etc.), or some combination of the two, accessible by the processing unit(s). The hardware components in FIG. 8 may be standard hardware components, or alternatively, some embodiments may employ specialized hardware components to further increase the operating efficiency and speed with which the system 100 operates.

Computing system 800 may have additional features such as for example, storage 810, one or more input devices 814, one or more output devices 812, and one or more communication connections 816. An interconnection mechanism (not shown) such as a bus, controller, or network interconnects the components of the computing system 800. Typically, operating system software (not shown) provides an operating system for other software executing in the computing system 800, and coordinates activities of the components of the computing system 800.

The tangible storage 810 may be removable or non-removable, and includes magnetic disks, magnetic tapes or cassettes, CD-ROMs, DVDs, or any other medium which can be used to store information in a non-transitory way and which can be accessed within the computing system 800. The storage 810 stores instructions for the software implementing one or more innovations described herein.

The input device(s) 814 may be a touch input device such as a keyboard, mouse, pen, or trackball, a voice input device, a scanning device, or another device that provides input to the computing system 800. For video encoding, the input device(s) 814 may be a camera, video card, TV tuner card, or similar device that accepts video input in analog or digital form, or a CD-ROM or CD-RW that reads video samples into the computing system 800. The output device(s) 812 may be a display, printer, speaker, CD-writer, or another device that provides output from the computing system 800.

The communication connection(s) 816 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or another carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “computing device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

What is claimed is:

1. A computer based decision simulation tool comprising:
data storage containing sales data for a plurality of products in a product line of a single brand, the sales data organized to include quantity sold, selling price and sale date of a product over a period of time, at a predetermined level of temporal granularity; and
a processor operatively coupled to the storage, the processor configured to execute instructions that when executed cause the processor to:
retrieve selected portions of the sales data;
identify dependencies among products within the product line to generate a cross-product price elasticity model that simulates percentage change in quantity sold of a focal product with respect to one percentage change in price of a different product in the product line; and
respond to user inputs to simulate effects of price changes of products in the product line on a product selected by the user for simulation.

2. The computer based decision simulation tool of claim 1 wherein the processor is programmed to execute instructions to generate the cross-product price elasticity model by:
processing the sales data to identify products that contain price dependencies over certain time periods on other products to generate a model data set; and
analyzing the model data set with a regression model to generate the cross-product price elasticity model.

3. The computer based decision simulation tool of claim 2 wherein the regression model is generated as a function of time and prices of a focal product with respect to changes in prices of other products, and a random error variable.

4. The computer based decision simulation tool of claim 3 wherein for each focal product, the regression model is employed to perform feature selection to arrive at the most appropriate model, wherein the feature selection comprises statistically choosing from among a plurality of products for which their prices affect quantity sold for the focal product.

5. The computer based decision simulation tool of claim 3 wherein the regression model performs estimation and variable selection simultaneously in one stage.

6. The computer based decision simulation tool of claim 3 wherein the regression model employs a linear demand curve.

7. The computer based decision simulation tool of claim 3 wherein the regression model employs a log linear demand curve.

8. The computer based decision simulation tool of claim 1 wherein the level of temporal granularity coincides with the period of time over which price of the products in the product line is changed.

9. The computer based decision simulation tool of claim 1 wherein the processor is programmed to execute instructions to respond to user inputs to simulate effects of price changes of products in the product line on a product selected by the user for simulation by:
receiving from the user, simulation inputs specifying,
a product for simulation;
a current price of the product for simulation;
a change in price of the product for simulation; and
a current price of a related product;
providing the simulation inputs to the cross-product price elasticity model to obtain effects of price changes of products in the product line on the product selected by the user for simulation; and
generating visual indications to the user of the effects of price changes of products in the product line on the product selected by the user for simulation.

10. The computer based decision simulation tool of claim 9 wherein the visual indications comprise a graph that shows modeling of quantity as a function of only price.

11. The computer based decision simulation tool of claim 9 wherein the visual indications comprise a graph that shows for a focal product a demand curve with a temporal effect.

12. The computer based decision simulation tool of claim 9 wherein the visual indications comprise a graph that shows for a focal product a demand curve with temporal effect and related product price.

13. The computer based decision simulation tool of claim 9 wherein the visual indications comprise a graph that shows values indicative of cross-product elasticities.

14. The computer based decision simulation tool of claim 1 wherein the sales data within the data storage is aggregated temporally as a function of change in price to the products in the product line.

15. A computer implemented method for simulating effects of pricing changes within a line of products comprising:
accessing sales data for the line of products, the sales data comprising quantity sold, selling price and sale date of each product within the line of products over a period of time;
temporally aggregating the sales data;
identifying within the sales data, features of interest;
employing the features of interest to process the aggregated sales data to generate a cross product price elasticity matrix that identifies dependencies among the products in the product line wherein the cross product price elasticity matrix models percentage change in quantity sold of a focal product with respect to one percentage change in price of a different product in the product line; and
responding to user inputs that select a product, within the line of products, for simulation with the cross product price elasticity matrix to provide visual indications of effect of price changes of other products in the product line on quantity sold of the product for analysis.

16. The computer implemented method of claim 15 further comprising:
responding to user inputs that select a product, within the line of products, for simulation with the cross product price elasticity matrix to provide visual indications of effect of price changes of the product for analysis on other products in the product line.

17. The computer implemented method of claim 15 further comprising:
generating the sales data by processing the sales data to identify and remove products in the product line whose price changes have no effect on quantity sold of other products.

18. A non-transitory computer-readable media storing instructions causing a computer to perform operations for simulating effects of pricing changes within a line of products, the operations comprising:
accessing sales data for the line of products, the sales data comprising quantity sold, selling price and sale date of each product within the line of products over a period of time;
temporally aggregating the sales data;
identifying within the sales data, features of interest;
employing the features of interest to process the aggregated sales data to generate a cross product price elasticity matrix that identifies dependencies among the products in the product line wherein the cross product price elasticity matrix models percentage change in quantity sold of a focal product with respect to one percentage change in price of a different product in the product line; and
responding to user inputs that select a product, within the line of products, for simulation with the cross product price elasticity matrix to provide visual indications of effect of price changes of other products in the product line on quantity sold of the product for analysis.

19. The computer computer-readable media of claim 18 wherein the operations further comprise:
responding to user inputs that select a product, within the line of products, for simulation with the cross product price elasticity matrix to provide visual indications of effect of price changes of the product for analysis on other products in the product line.

20. The computer computer-readable media of claim 18 wherein the operations further comprise:
generating the sales data by processing the sales data to identify and remove products in the product line whose price changes have no effect on quantity sold of other products.
